(19) United States
(12) Patent Application Publication
(10) Pub. No.: US 2026/0336293 A1
(43) Pub. Date: Oct. 29, 2026

(54) LIQUID EJECTION HEAD AND LIQUID EJECTION APPARATUS

(71) Applicant: KYOCERA CORPORATION, Kyoto-shi, Kyoto (JP)

(72) Inventor: Naoki KOBAYASHI, Kirishima-shi, Kagoshima (JP)

(21) Appl. No.: 19/123,070

(22) PCT Filed: Nov. 17, 2023
(86) PCT No.: PCT/JP2023/041546

§ 371 Date: Apr. 22, 2025

(30) Foreign Application Priority Data
Dec. 2, 2022 (JP) 2022-193447

(51) Int. Cl. B41J 2/14; B41J 2/175; B41J 2/185

(52) U.S. Cl. CPC B41J 2/14233; B41J 2/17596; B41J 2/185; B41J 2002/14419; B41J 2202/12

(57) ABSTRACT

A liquid ejection head includes a plurality of individual channels, a first common channel, a second common channel, a supply channel, and a collection channel. Each of the individual channels includes a pressure chamber, a first narrower portion located between one end and another end, and a second narrower portion located between the other end and the pressure chamber. Each of the individual channels includes the one end connected to the first common channel and the other end connected to the second common channel. The supply channel is connected to the first common channel. The collection channel is connected to the second common channel. The combined channel resistance of the second common channel, the collection channel, and the first narrower portion is higher than the combined channel resistance of the first common channel, the supply channel, and the second narrower portion.

### TECHNICAL FIELD

The present invention relates to a liquid ejection head and a liquid ejection apparatus including the liquid ejection head.

### BACKGROUND OF INVENTION

A known liquid ejection apparatus includes a liquid ejection head (refer to, for example, Patent Literature 1). The liquid ejection head includes multiple individual channels, a first common liquid chamber, and a second common liquid chamber. Each of the multiple individual channels includes a nozzle and a pressure chamber. The nozzle includes an ejection orifice for ejecting a liquid. The first common liquid chamber is connected to first connectors in respective individual channels. The second common liquid chamber is connected to second connectors in respective individual channels. In the liquid ejection head, the first common liquid chamber functions as a supply channel system for supplying a liquid to each of the multiple individual channels, and the second common liquid chamber functions as a collection channel system for collecting a liquid not ejected out of the ejection orifice in each of the multiple individual channels.

### CITATION LIST

### Patent Literature

Patent Literature 1: Japanese Unexamined Patent Application Publication No. 2020-138373

### SUMMARY

One or more aspects of the present invention are directed to a liquid ejection head and a liquid ejection apparatus including the liquid ejection head that are less likely to cause a backflow of a liquid from the collection channel system to each of the individual channels while the liquid is being ejected out of the ejection orifice.

In one aspect of the present disclosure, a liquid ejection head includes a plurality of individual channels through which a liquid flows, a first common channel, a second common channel, a supply channel, and a collection channel. Each of the plurality of individual channels includes one end, another end, and an ejection orifice located between the one end and the other end to eject the liquid. The first common channel includes a first opening and connected to the one end of each of the plurality of individual channels. The second common channel includes a second opening and connected to the other end of each of the plurality of individual channels. The supply channel includes an inlet through which the liquid flows in from outside. The supply channel is connected to the first opening in the first common channel to supply the liquid flowing in through the inlet to the first common channel through the first opening. The collection channel includes an outlet through which the liquid flows to the outside. The collection channel is connected to the second opening in the second common channel to allow the liquid collected from the second common channel through the second opening to flow to the outlet. Each of the plurality of individual channels includes a pressure chamber, a first narrower portion, and a second narrower portion. The pressure chamber is located between the one end and the other end and connected with the ejection orifice. The pressure chamber has a pressure applier that applies pressure to the pressure chamber. The first narrower portion is located between the one end and the pressure chamber and has a higher channel resistance than the pressure chamber. The second narrower portion is located between the other end and the pressure chamber and has a higher channel resistance than the pressure chamber. A combined channel resistance of the second common channel, the collection channel, and the second narrower portion is higher than a combined channel resistance of the first common channel, the supply channel, and the first narrower portion.

In one aspect of the present disclosure, a liquid ejection head includes a plurality of individual channels through which a liquid flows, a first common channel, a second common channel, a supply channel, and a collection channel. Each of the plurality of individual channels includes one end, another end, and an ejection orifice located between the one end and the other end to eject the liquid. The first common channel includes a first opening and connected to the one end of each of the plurality of individual channels. The second common channel includes a second opening and connected to the other end of each of the plurality of individual channels. The supply channel includes an inlet through which the liquid flows in from outside. The supply channel is connected to the first opening in the first common channel to supply the liquid flowing in through the inlet to the first common channel through the first opening. The collection channel includes an outlet through which the liquid flows to the outside. The collection channel is connected to the second opening in the second common channel to allow the liquid collected from the second common channel through the second opening to flow to the outlet. Each of the plurality of individual channels includes a pressure chamber, a first narrower portion, and a second narrower portion. The pressure chamber is located between the one end and the other end and connected with the ejection orifice. The pressure chamber has a pressure applier to apply pressure to the pressure chamber. The first narrower portion is located between the one end and the pressure chamber and has a higher channel resistance than the pressure chamber. The second narrower portion is located between the other end and the pressure chamber and has a higher channel resistance than the pressure chamber. A sum of channel cross-sectional areas of the second common channel, the collection channel, and the second narrower portion is less than a sum of channel cross-sectional areas of the first common channel, the supply channel, and the first narrower portion.

In another aspect of the present disclosure, a liquid ejection apparatus includes the liquid ejection head described above and a circulator connected to the inlet and the outlet of the liquid ejection head. The circulator circulates the liquid through the liquid ejection head.

### BRIEF DESCRIPTION OF THE DRAWINGS

FIG. 1 is a side view of a printer as a liquid ejection apparatus according to one embodiment of the present invention.

FIG. 2 is a plan view of the printer.

FIG. 3 is a schematic diagram describing the relationship between a liquid ejection head and a circulator in the printer.

FIG. 4 is a plan view of a first channel member and a second channel member included in a head body of the liquid ejection head.

FIG. 5 is a cross-sectional view of a main part of the first channel member.

FIG. 6 is a cross-sectional view of the second channel member taken along line VI-VI in FIG. 4.

FIG. 7 is a cross-sectional view of the second channel member taken along line VII-VII in FIG. 4.

FIG. 8 is a cross-sectional view of the second channel member taken along line VIII-VIII in FIG. 4.

FIG. 9 is a plan view of plates included in the second channel member.

FIG. 10 is a graph showing changes in the flow rate of ink as a liquid ejected from the liquid ejection head.

### DESCRIPTION OF EMBODIMENTS

A liquid ejection head and a liquid ejection apparatus according to one or more embodiments of the present invention will now be described with reference to the drawings. The liquid ejection apparatus includes a liquid ejection head for ejecting a liquid. Examples of the liquid ejection apparatus include a recording apparatus that causes a liquid ejection head to eject ink as the liquid, an apparatus that causes a liquid ejection head to eject a liquid containing electrically conductive particles to print a wiring pattern of an electronic device, and an apparatus that causes a liquid ejection head to eject a liquid such as a chemical agent toward a reaction container to produce chemicals. In the embodiments described below, a specific example of the liquid ejection apparatus is an inkjet printer as a recording apparatus including a liquid ejection head that ejects ink as the liquid. The inkjet printer is a recording apparatus that prints an image of, for example, characters or patterns on a workpiece such as a paper sheet, a resin sheet, woven fabric, or knitted fabric with an inkjet printing system.

### Overall Structure of Printer

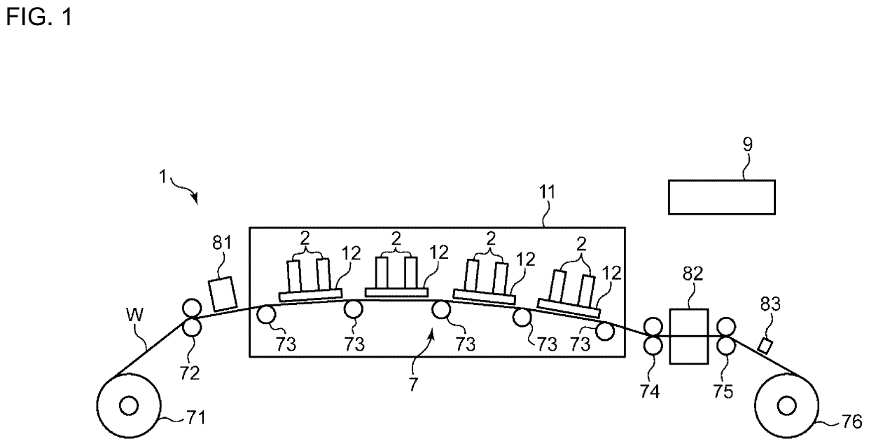

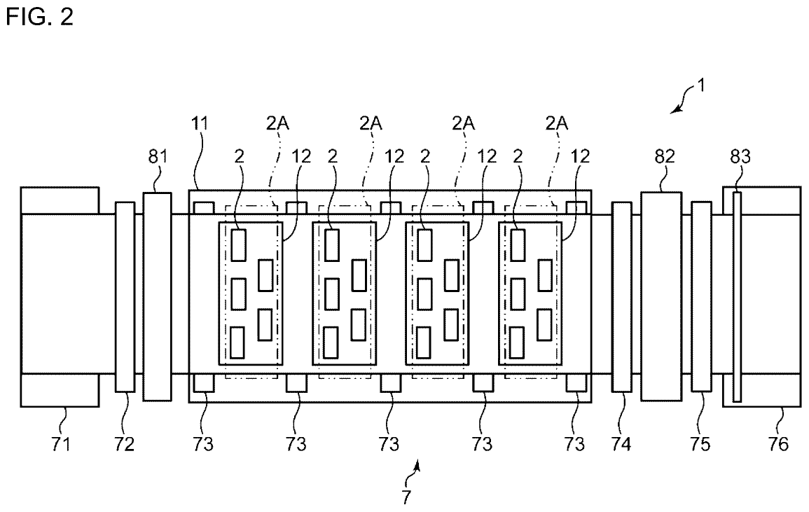

As illustrated in FIGS. 1 and 2, a printer 1 includes liquid ejection heads 2 for ejecting ink, a mover 7 for moving a workpiece W relative to the liquid ejection heads 2, and a controller 9. In the printer 1, the controller 9 controls the liquid ejection heads 2 based on print data as image data to eject ink toward the workpiece W moved by the mover 7. With the ink reaching the workpiece W as droplets, the printer 1 performs recording, such as printing, on the workpiece W.

In the present embodiment, the printer 1 is a line printer in which the liquid ejection heads 2 are fixed to head mount frames 12 in a head chamber 11. In another embodiment, the printer 1 may be a serial printer that reciprocates the liquid ejection heads 2 in a direction intersecting with a feed direction of the workpiece W to alternately perform an operation of ejecting ink from the liquid ejection head 2 and an operation of feeding the workpiece W.

In the printer 1, the head chamber 11 accommodates four flat head mount frames 12. Each of the head mount frames 12 receives a head group 2A including five liquid ejection heads 2. The printer 1 includes four head groups 2A and thus twenty liquid ejection heads 2 in total.

The liquid ejection heads 2 are elongated in one direction. The liquid ejection heads 2 are mounted on the head mount frames 12 with their ink ejection orifices facing a print surface of the workpiece W from above and their lengths parallel to a direction perpendicular to the feed direction of the workpiece W. In one head group 2A, three of the liquid ejection heads 2 are aligned in the direction perpendicular to the feed direction of the workpiece W. The remaining two of the liquid ejection heads 2 are each between adjacent ones of the three liquid ejection heads 2 at positions shifted from the three in the feed direction. In other words, in one head group 2A, the liquid ejection heads 2 are arranged in a staggered manner. In one head group 2A, the liquid ejection heads 2 are arranged to allow continuous printing on the workpiece W in a width direction of the workpiece W, or more specifically, in the direction perpendicular to the feed direction of the workpiece W. With the liquid ejection heads 2 in the head group 2A arranged in this manner, printing can be performed continuously in the width direction of the workpiece W based on the ejection of ink from the liquid ejection heads 2.

The four head groups 2A are arranged in the feed direction of the workpiece W. The liquid ejection heads 2 in one head group 2A are supplied with ink of the same color. The four head groups 2A thus allow printing with four colors of ink. The colors of the ink are, for example, magenta (M), yellow (Y), cyan (C), and black (BK).

The mover 7 moves the workpiece W relative to the liquid ejection heads 2 mounted on the head mount frames 12 in the head chamber 11. The mover 7 includes a feed roller 71 and a feed adjustment roller 72 upstream from the head chamber 11 in the feed direction of the workpiece W. The mover 7 includes transport rollers 73 in the head chamber 11. The mover 7 includes a first take-up adjustment roller 74, a second take-up adjustment roller 75, and a take-up roller 76 downstream from the head chamber 11 in the feed direction of the workpiece W. The feed roller 71 feeds the workpiece W. The feed adjustment roller 72 guides the workpiece W fed by the feed roller 71 into the head chamber 11. The transport rollers 73 feed the workpiece W guided by the feed adjustment roller 72 into the head chamber 11 to pass under the liquid ejection heads 2. The first take-up adjustment roller 74 and the second take-up adjustment roller 75 guide the workpiece W fed by the transport roller 73 out of the head chamber 11. The take-up roller 76 winds and collects the workpiece W guided by the first take-up adjustment roller 74 and the second take-up adjustment roller 75 out of the head chamber 11.

As illustrated in FIGS. 1 and 2, the printer 1 in the present embodiment includes a coating applicator 81 between the feed adjustment roller 72 and the head chamber 11, a dryer 82 between the first take-up adjustment roller 74 and second take-up adjustment roller 75, and an imager 83 between the second take-up adjustment roller 75 and the take-up roller 76 in the feed direction of the workpiece W.

The coating applicator 81 applies a coating agent to the workpiece W before being guided into the head chamber 11. When, for example, the workpiece W is a material that is less likely to absorb ink, the coating agent may be an agent that forms an ink receiving layer on the workpiece W to facilitate fixing of ink on the workpiece W. When the workpiece W is a material that easily absorbs ink, the coating agent may be an agent that forms an ink seepage control layer on the workpiece W to reduce excess bleeding of ink and excess mixing of adjacent droplets of different inks.

The dryer 82 dries ink on the workpiece W before being wound by the take-up roller 76. The dryer 82 dries ink by, for example, blowing warm air, applying infrared rays, or applying a heated roller.

The imager 83 captures an image of the workpiece W that has been dried by the dryer 82, and obtains image data to examine the printing state of the ink on the workpiece W. The image data obtained by the imager 83 is input into the controller 9. The controller 9 evaluates the printing state of the ink on the workpiece W based on the image data. More specifically, the controller 9 evaluates the printing state by, for example, determining whether any pixel is unprinted due to ejection failure of ink droplets from the liquid ejection heads 2 or whether any ink droplets ejected from the liquid ejection heads 2 have reached a deviating position.

### Detailed Structure of Liquid Ejection Head

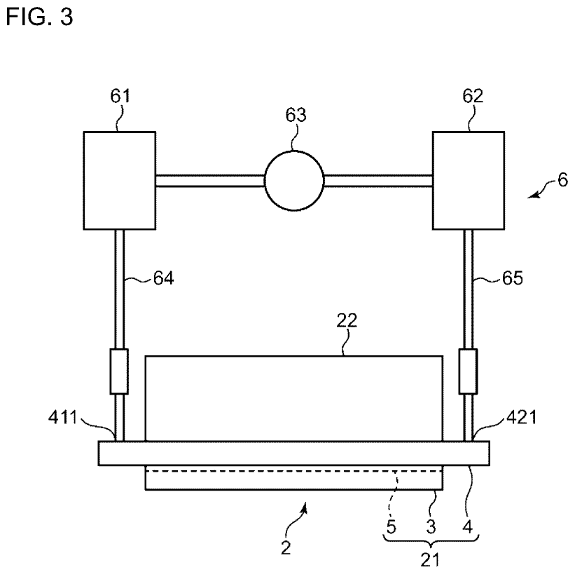

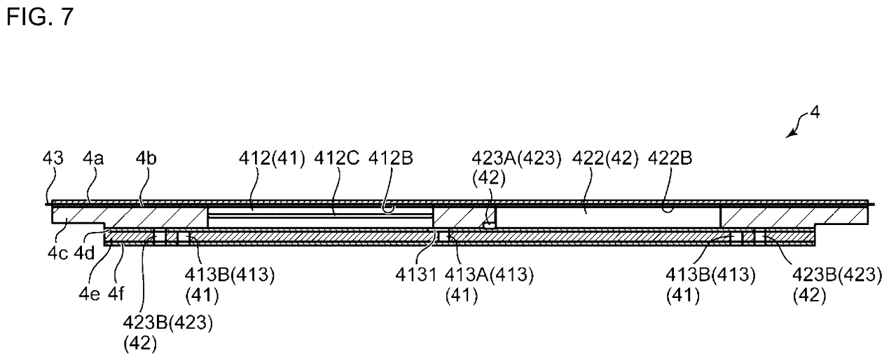

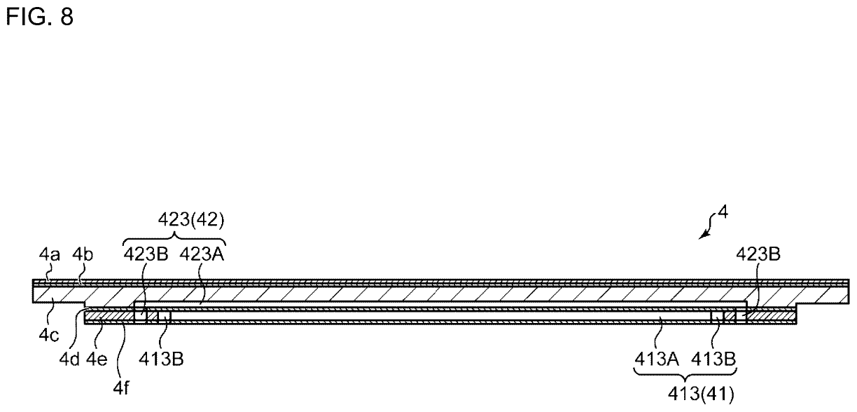

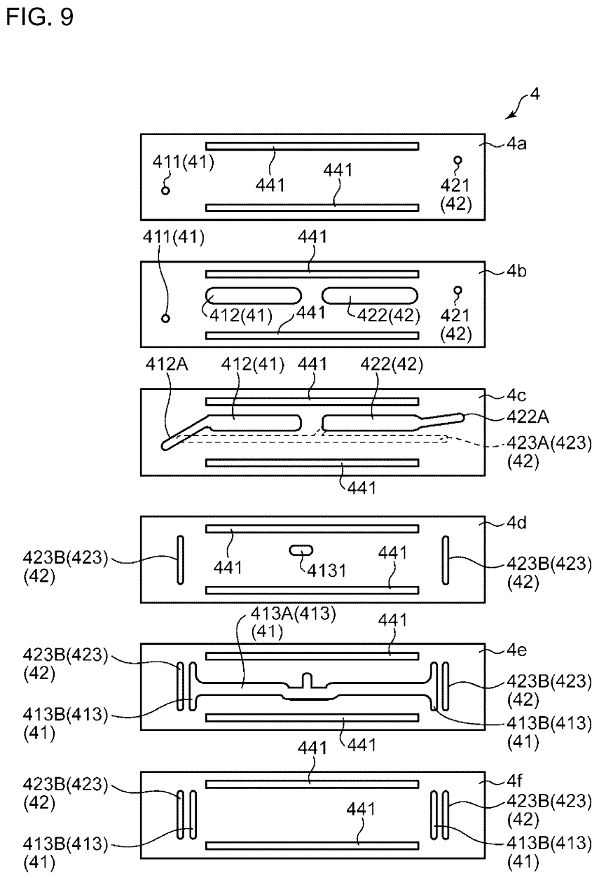

The liquid ejection heads 2 will now be described in detail with reference to FIGS. 3 to 9. Note that the positions outward from the liquid ejection heads 2 are hereafter referred to as outside. Each of the liquid ejection heads 2 includes a head body 21 and a housing 22. The head body 21 includes, for example, a channel for ejecting ink. The housing 22 is connected to the head body 21 and accommodating, for example, a driver IC and a wiring board for controlling operations of ink ejection.

The head body 21 is a flat plate elongated in one direction. The directional relationships used hereafter are defined as below. The head body 21 is elongated in a longitudinal direction D1. One of the two opposite directions aligned with the longitudinal direction D1 is referred to as a first direction D11, and the other is referred to as a second direction D12. A width direction D2 is perpendicular to the longitudinal direction D1 of the head body 21. One of the two opposite directions aligned with the width direction D2 is referred to as a third direction D21, and the other is referred to as a fourth direction D22. A direction perpendicular to the longitudinal direction D1 and the width direction D2 of the head body 21 is referred to as a thickness direction D3 of the head body 21. For each of the liquid ejection heads 2 mounted on the corresponding one of the head mount frames 12, the longitudinal direction D1 of the head body 21 is parallel to the direction perpendicular to the feed direction of the workpiece W, the width direction D2 of the head body 21 is parallel to the feed direction of the workpiece W, and the thickness direction D3 of the head body 21 is parallel to a vertical direction perpendicular to the print surface of the workpiece W.

As illustrated in FIG. 3, the head body 21 includes a first channel member 3 at its lower part, a second channel member 4 at its upper part, and a piezoelectric actuator substrate 5 between the first channel member 3 and the second channel member 4. The first channel member 3 is a flat plate including channels for ejecting ink in response to actuation of the piezoelectric actuator substrate 5. The second channel member 4 is a flat plate including an inlet 411 through which ink flows in from the outside and an outlet 421 through which ink flows to the outside. The second channel member 4 includes a channel to supply ink flowing in through the inlet 411 to the first channel member 3 and a channel to allow the ink collected from the first channel member 3 to flow to the outlet 421.

As illustrated in FIG. 3, a circulator 6 is located outside the liquid ejection head 2. The circulator 6 is connected to the inlet 411 and the outlet 421 of the head body 21. The circulator 6 causes ink to flow from the outlet 421 to the inlet 411 to circulate ink through the head body 21.

The circulator 6 includes a supply storage 61, a collection storage 62, a pump 63, an external supply channel 64, and an external collection channel 65. The supply storage 61 stores ink to be supplied to the inlet 411 of the head body 21. The collection storage 62 stores ink flowing out of the outlet 421 of the head body 21. The pump 63 pumps ink from the collection storage 62 to the supply storage 61. The external supply channel 64 connects the supply storage 61 to the inlet 411 of the head body 21 to define a channel through which the ink stored in the supply storage 61 flows to the inlet 411. The external collection channel 65 connects the collection storage 62 to the outlet 421 of the head body 21 to define a channel through which the ink flowing out of the outlet 421 flows into the collection storage 62.

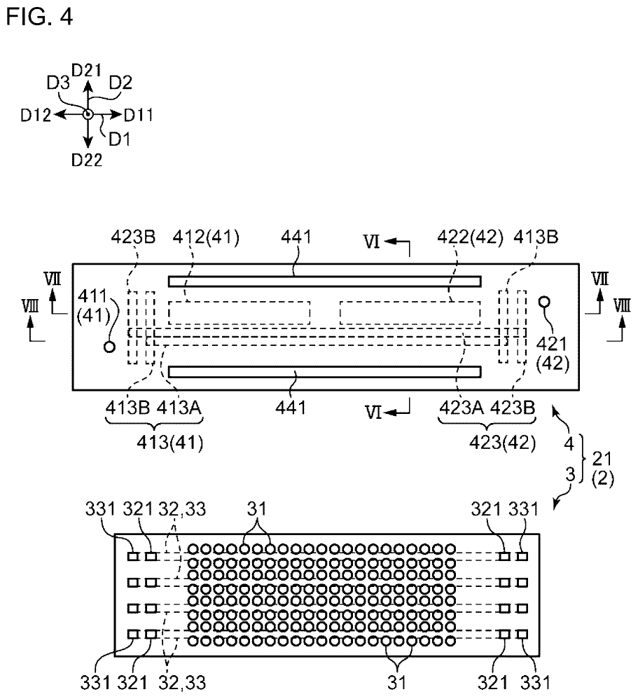

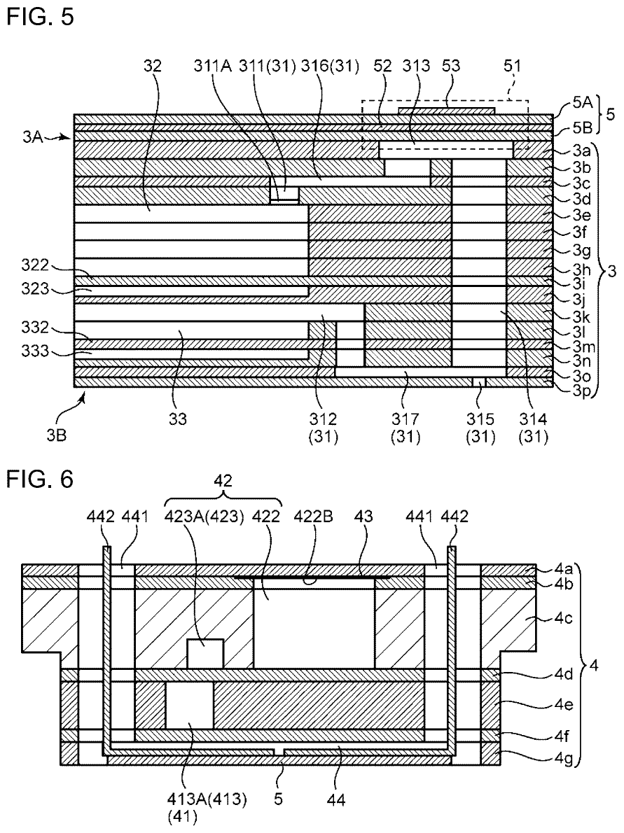

As illustrated in FIGS. 4 and 5, the first channel member 3 at the lower part of the head body 21 includes multiple individual channels 31, at least one first common channel 32, and at least one second common channel 33. The first common channel 32 is connected to one end 311 as an inlet of each of the multiple individual channels 31. The second common channel 33 is connected to another end 312 as an outlet of each of the multiple individual channels 31. In the present embodiment, the first channel member 3 includes multiple first common channels 32 each connected to the end 311 of the corresponding one of the individual channels 31 and multiple second common channels 33 each connected to the other end 312 of the corresponding one of the individual channels 31. For example, the first channel member 3 includes four first common channels 32 and four second common channels 33.

Each of the multiple individual channels 31 includes the end 311 connected to the corresponding one of the first common channels 32 and the other end 312 connected to the corresponding one of the second common channels 33 to allow ink to flow from the end 311 to the other end 312. In each of the individual channels 31, the end 311 is an upstream end in the flow direction of the ink as well as the inlet of the individual channel 31, and the other end 312 is a downstream end in the flow direction of the ink as well as the outlet of the individual channel 31. Each of the individual channels 31 has, for example, a rectangular cross section perpendicular to the flow direction of the ink. Each of the individual channels 31 includes a pressure chamber 313 on an upper surface 3A of the first channel member 3 between the end 311 and the other end 312, an ejection orifice 315 in a lower surface 3B of the first channel member 3 between the end 311 and the other end 312, and a descender 314 connecting the pressure chamber 313 to the ejection orifice 315.

The pressure chamber 313 is open upward in the upper surface 3A of the first channel member 3 and connects with the ejection orifice 315 through the descender 314. The upper surface 3A of the first channel member 3 receives the piezoelectric actuator substrate 5 to cover the opening of the pressure chamber 313. This allows a displacement element 51 incorporated in the piezoelectric actuator substrate 5 to be located over the pressure chamber 313. The displacement element 51 functions as a pressure applier that applies pressure to the pressure chamber 313. The descender 314 extends downward from the pressure chamber 313 to the ejection orifice 315 in the thickness direction D3 of the first channel member 3. The descender 314 includes an upper end connected to the pressure chamber 313 and a lower end connected to the ejection orifice 315. The ejection orifice 315 is open downward in the lower surface 3B of the first channel member 3. The ejection orifice 315 ejects the ink passing through the descender 314 after receiving pressure in the pressure chamber 313 in response to actuation of the displacement element 51.

Each of the multiple first common channels 32 extends in the longitudinal direction D1 of the first channel member 3. The ink flows through each of the multiple first common channels 32 parallel to the longitudinal direction D1 of the first channel member 3. Each of the first common channels 32 is connected to the end 311 of the corresponding one of the individual channels 31 to function as a supply channel system for supplying ink to the corresponding individual channel 31. Each of the first common channels 32 has, for example, a rectangular cross section perpendicular to the flow direction of the ink. Each of the first common channels 32 has the same channel cross-sectional area, which indicates an area of its cross section, across two ends of the first common channel 32 in the longitudinal direction D1. More specifically, each of the first common channels 32 has a uniform cross-sectional area in the flow direction of the ink. The first common channels 32 are aligned in the width direction D2 of the first channel member 3. Each of the first common channels 32 includes a first opening 321 at its end in the first direction D11 of the longitudinal direction D1 and a first opening 321 at its end in the second direction D12 of the longitudinal direction D1 to receive ink supplied from the second channel member 4 to the first channel member 3. In each of the first common channels 32, substantially the same amount of ink is supplied from the second channel member 4 to the first opening 321 at the end in the first direction D11 and to the first opening 321 at the end in the second direction D12. The ink supplied to the first openings 321 at the two ends of the first common channel 32 flows toward the middle of the first common channel 32 in the longitudinal direction D1. The ink flowing through each of the first common channels 32 is supplied to the corresponding one of the individual channels 31 including the end 311 connected to the first common channel 32.

Each of the first common channels 32 and the end 311 of the corresponding one of the individual channels 31 are connected with a first filter 311A between the first common channel 32 and the end 311. The first filter 311A allows the ink in the first common channel 32 to flow into the corresponding one of the individual channels 31, and restricts, for example, foreign substances in the ink from flowing into the corresponding individual channel 31.

In the first channel member 3, each of the first common channels 32 includes a lower surface serving as a first damper 322. The first damper 322 includes a surface facing the first common channel 32 and an opposite surface opposite to the surface facing the first common channel 32. The opposite surface faces a first damper chamber 323 accommodating a gas such as air. The first damper chamber 323 has a volume that varies under pressure applied from the first common channel 32. The first damper 322 vibrates in response to changes of the volume of the first damper chamber 323. The vibration of the first damper 322 attenuates to reduce the pressure fluctuation in the first common channel 32. The first damper 322 in each of the first common channels 32 can thus reduce pressure fluctuation, such as resonance of the ink, in the first common channel 32.

The multiple second common channels 33 extend in the longitudinal direction D1 below the first common channels 32 in the first channel member 3. The ink flows through each of the multiple second common channels 33 parallel to the longitudinal direction D1 of the first channel member 3. Each of the multiple second common channels 33 is connected to the other end 312 of the corresponding one of the multiple individual channels 31 to function as a collection channel system for collecting ink not ejected out of the ejection orifices 315 in the corresponding multiple individual channels 31. Each of the second common channels 33 has, for example, a rectangular cross section perpendicular to the flow direction of the ink. Each of the second common channels 33 has the same channel cross-sectional area, which indicates an area of its cross section, across two ends of the second common channel 33 in the longitudinal direction D1. More specifically, each of the second common channels 33 has a uniform cross-sectional area in the flow direction of the ink. The second common channels 33 are aligned in the width direction D2 of the first channel member 3. Each of the second common channels 33 includes a second opening 331 at its end in the first direction D11 of the longitudinal direction D1 and a second opening 331 at its end in the second direction D12 of the longitudinal direction D1 to direct, to the second channel member 4, the ink not ejected out of the ejection orifice 315 of the corresponding one of the individual channels 31 and collected in the second common channel 33. Each of the second common channels 33 collects ink from the corresponding one of the individual channels 31 including the other end 312 connected to the second common channel 33. The collected ink then flows toward and through the second openings 331 at the ends of the second common channel 33 to be collected into the second channel member 4.

In the first channel member 3, each of the second common channels 33 includes a lower surface serving as a second damper 332. The second damper 332 includes a surface facing the second common channel 33 and an opposite surface opposite to the surface facing the second common channel 33. The opposite surface faces a second damper chamber 333 accommodating a gas such as air. The second damper chamber 333 has a volume that varies under pressure applied from the second common channel 33. The second damper 332 vibrates in response to changes of volume of the second damper chamber 333. The vibration of the second damper 332 attenuates to reduce the pressure fluctuation in the second common channel 33. The second damper 332 in each of the second common channels 33 can thus reduce pressure fluctuation, such as resonance of the ink, in the second common channel 33.

The first common channels 32 overlap the respective second common channels 33 as viewed in plan in the thickness direction D3 of the first channel member 3. The multiple individual channels 31, each of which includes the end 311 connected to the corresponding one of the first common channels 32 and the other end 312 connected to the corresponding one of the second common channels 33, are aligned in the longitudinal direction D1 on both ends of the respective first common channels 32 and the respective second common channels 33 in the width direction D2.

Each of the multiple individual channels 31 includes a first narrower portion 316 between the end 311 and the pressure chamber 313 and a second narrower portion 317 between the other end 312 and the pressure chamber 313. The second narrower portion 317 is connected to the lower end of the descender 314 including the ejection orifice 315.

The first narrower portion 316 extends in the width direction D2 of the first channel member 3 between the end 311 and the pressure chamber 313 of the individual channel 31. The first narrower portion 316 connects with the corresponding one of the first common channels 32 connected to the end 311 of the individual channel 31 and with the pressure chamber 313. The ink flows through the first narrower portion 316 parallel to the width direction D2 of the first channel member 3. The first narrower portion 316 has, for example, a rectangular cross section perpendicular to the flow direction of the ink. The first narrower portion 316 has the same channel cross-sectional area, which indicates an area of its cross section, across two ends the first narrower portion 316. More specifically, the first narrower portion 316 has a uniform cross-sectional area in the flow direction of the ink. The first narrower portion 316 has a smaller cross-sectional area than the corresponding first common channel 32, and has a smaller cross-sectional area than the pressure chamber 313 and the descender 314. This allows the first narrower portion 316 to have a higher channel resistance than the corresponding first common channel 32, and has a higher channel resistance than the pressure chamber 313 and the descender 314.

The second narrower portion 317 extends in the width direction D2 of the first channel member 3 between the other end 312 of the individual channel 31 and the lower end of the descender 314. The second narrower portion 317 connects with the corresponding one of the second common channels 33 connected to the other end 312 of the individual channel 31, and connects with the pressure chamber 313 and the ejection orifice 315 through the descender 314. The ink flows through the second narrower portion 317 parallel to the width direction D2 of the first channel member 3. The second narrower portion 317 has, for example, a rectangular cross section perpendicular to the flow direction of the ink. The second narrower portion 317 has the same channel cross-sectional area, which indicates an area of its cross section, across two ends of the second narrower portion 317. More specifically, the second narrower portion 317 has a uniform cross-sectional area in the flow direction of the ink. The second narrower portion 317 has a smaller cross-sectional area than the corresponding one of the second common channels 33, and has a smaller cross-sectional area than the pressure chamber 313 and the descender 314. This allows the second narrower portion 317 to have a higher channel resistance than the corresponding second common channel 33 and have a higher channel resistance than the pressure chamber 313 and the descender 314.

In the first channel member 3 including the multiple individual channels 31, the first common channels 32, and the second common channels 33, the ink supplied from the second channel member 4 to the first channel member 3 flows into the first common channels 32 through the first openings 321. The ink that has flowed into the first common channels 32 flows into each of the individual channels 31 through the end 311 at which the corresponding one of the first common channel 32 is connected to the individual channel 31. The ink that has flowed into each of the individual channels 31 through the end 311 passes through the first narrower portion 316, and then flows into the pressure chamber 313. The ink that has flowed into the pressure chamber 313 flows through the descender 314. The ink is then partially ejected out of the ejection orifice 315. The remaining ink not ejected out of the ejection orifice 315 passes through the second narrower portion 317, and then flows into the corresponding one of the second common channels 33 through the other end 312. The ink that has flowed into the second common channel 33 then flows, through the second opening 331, toward the second channel member 4 to be collected.

As illustrated in FIG. 5, the first channel member 3 has a multilayer structure in which multiple plates are stacked in the thickness direction D3. In the example in FIG. 5, the first channel member 3 includes sixteen plates as a first plate 3a, a second plate 3b, a third plate 3c, a fourth plate 3d, a fifth plate 3e, a sixth plate 3f, a seventh plate 3g, an eighth plate 3h, a ninth plate 3i, a tenth plate 3j, an eleventh plate 3k, a twelfth plate 3l, a thirteenth plate 3m, a fourteenth plate 3n, a fifteenth plate 3o, and a sixteenth plate 3p stacked in this order from the top.

In each of the individual channels 31, the end 311 is defined by a hole in the fourth plate 3d, and the other end 312 is defined by a hole in the eleventh plate 3k. In each of the individual channels 31, the pressure chamber 313 is defined by a hole in the first plate 3a as a top layer. In each of the individual channels 31, the descender 314 is defined by holes in the respective second to fifteenth plates 3b to 3o to connect with the hole in the first plate 3a defining the pressure chamber 313. In each of the individual channels 31, the ejection orifice 315 is defined by a hole in the sixteenth plate 3p as a bottom layer to connect with the holes in the respective second to fifteenth plates 3b to 3o defining the descender 314. In each of the individual channels 31, the first narrower portion 316 is defined by the hole in the third plate 3c to connect with the hole in the fourth plate 3d defining the end 311 and the hole in the first plate 3a defining the pressure chamber 313. In each of the individual channels 31, the second narrower portion 317 is defined by the hole in the fifteenth plate 3o to connect with the hole in the eleventh plate 3k defining the other end 312, the hole in the fifteenth plate 3o defining the lower end of the descender 314, and the hole in the sixteenth plate 3p defining the ejection orifice 315.

Each of the first common channels 32 is defined by the holes in the respective fifth to eighth plates 3e to 3h to connect with the hole in the fourth plate 3d defining the end 311 of the corresponding one of the individual channels 31. In each of the first common channels 32, the first damper 322 is part of the ninth plate 3i facing the hole in the eighth plate 3h defining the lower end of the first common channel 32. The first damper chamber 323 for the first damper 322 is defined by a groove on the tenth plate 3j.

Each of the second common channels 33 is defined by the holes in the respective eleventh and twelfth plates 3k and 3l to connect with the hole in the eleventh plate 3k defining the other end 312 in the corresponding one of the individual channels 31. In each of the second common channels 33, the second damper 332 is part of the thirteenth plate 3m facing the hole in the twelfth plate 3l defining the lower end of the second common channel 33. The second damper chamber 333 for the second damper 332 is defined by a groove on the fourteenth plate 3n.

The second channel member 4 located in an upper portion of the head body 21 is bonded to an area of the upper surface 3A of the first channel member 3 not connected to the piezoelectric actuator substrate 5. More specifically, the second channel member 4 is bonded to the upper surface 3A of the first channel member 3 to surround the piezoelectric actuator substrate 5. As illustrated in FIG. 4 and FIGS. 6 to 9, the second channel member 4 includes a supply channel 41 and a collection channel 42.

The supply channel 41 allows flow of ink to be supplied to each of the first common channels 32 in the first channel member 3. The supply channel 41 includes the inlet 411 receiving the ink flowing through the external supply channel 64 in the circulator 6 connected to the head body 21 outside the liquid ejection head 2. The inlet 411 is open upward and outward in an end area of the second channel member 4 in the second direction D12 of the longitudinal direction D1. The supply channel 41 is connected to the first openings 321 in each of the first common channels 32 to supply, through the first openings 321, the ink that has flowed in through the inlet 411 to the first common channel 32.

The supply channel 41 includes an inflow connection channel 412A connected to the inlet 411, a supply chamber 412 connecting with the inlet 411 through the inflow connection channel 412A, a branch connection channel 4131 connected to the supply chamber 412, and a supply branch channel 413 connecting with the supply chamber 412 through the branch connection channel 4131.

The inflow connection channel 412A connects the inlet 411 to the supply chamber 412. The supply chamber 412 is located farther in the second direction D12 than a middle portion of the second channel member 4 in the longitudinal direction D1, and extends in the longitudinal direction D1 of the second channel member 4. The ink flows through the supply chamber 412 parallel to the longitudinal direction D1 of the second channel member 4. The supply chamber 412 has, for example, a rectangular cross section perpendicular to the flow direction of the ink. The supply chamber 412 has the same channel cross-sectional area, which indicates an area of its cross section, across two ends of the supply chamber 412 in the longitudinal direction D1. More specifically, the supply chamber 412 has a uniform cross-sectional area in the flow direction of the ink. The supply chamber 412 can store the ink flowing in through the inlet 411. The supply chamber 412 includes an external supply opening 412B facing upward and open outward.

The supply chamber 412 includes the external supply opening 412B covered with an elastic film 43 that is elastically deformable. The supply chamber 412 has a volume that varies in response to elastic deformation of a portion of the elastic film 43 facing the external supply opening 412B. The elastic film 43 vibrates in response to elastic deformation that varies the volume of the supply chamber 412. The vibration of the elastic film 43 attenuates to reduce the pressure fluctuation in the supply chamber 412. With the external supply opening 412B in the supply chamber 412 covered with the elastic film 43, the pressure fluctuation, such as resonance of the ink, in the supply chamber 412 can be reduced.

The supply chamber 412 includes a second filter 412C. The second filter 412C allows the ink in the supply chamber 412 to flow through to the supply branch channel 413, and restricts, for example, foreign substances in the ink from flowing through to the supply branch channel 413.

The branch connection channel 4131 is located in the middle portion of the second channel member 4 in the longitudinal direction D1 and connects the supply chamber 412 to the supply branch channel 413.

The supply branch channel 413 connects with the supply chamber 412 through the branch connection channel 4131, and is connected to the first openings 321 to connect with each of the first common channels 32 in the first channel member 3. The supply branch channel 413 includes a first supply branch channel 413A and a second supply branch channel 413B.

The first supply branch channel 413A is connected to the branch connection channel 4131 in the middle portion of the second channel member 4 in the longitudinal direction D1, and extends in the longitudinal direction D1. The first supply branch channel 413A branches in a portion connected to the branch connection channel 4131 to extend in the first direction D11 and in the second direction D12. The ink flows through the first supply branch channel 413A parallel to the longitudinal direction D1 of the second channel member 4. The first supply branch channel 413A has, for example, a rectangular cross section perpendicular to the flow direction of the ink. The first supply branch channel 413A has the same channel cross-sectional area, which indicates an area of its cross section, across two ends of the first supply branch channel 413A in the longitudinal direction D1. More specifically, the first supply branch channel 413A has a uniform cross-sectional area in the flow direction of the ink.

The second supply branch channel 413B is connected to an end of the first supply branch channel 413A in the first direction D11 of the longitudinal direction D1 and connected to an end of the first supply branch channel 413A in the second direction D12 of the longitudinal direction D1 to extend in the width direction D2. The second supply branch channel 413B is then connected to the first openings 321 of each of the first common channels 32 in the first channel member 3. The second supply branch channel 413B branches in a portion connected to the first supply branch channel 413A to extend in the third direction D21 of the width direction D2 and in the fourth direction D22 of the width direction D2. The ink flows through the second supply branch channel 413B parallel to the width direction D2 of the second channel member 4. The second supply branch channel 413B has, for example, a rectangular cross section perpendicular to the flow direction of the ink. The second supply branch channel 413B has the same channel cross-sectional area, which indicates an area of its cross section, across two ends of the second supply branch channel 413B. More specifically, the second supply branch channel 413B has a uniform cross-sectional area in the flow direction of the ink.

The collection channel 42 allows flow of the ink collected from each of the second common channels 33 in the first channel member 3. The collection channel 42 includes the outlet 421 through which ink flows out to the external collection channel 65 in the circulator 6 connected to the head body 21 outside the liquid ejection head 2. The outlet 421 is open upward and outward in an end area of the second channel member 4 in the first direction D11 of the longitudinal direction D1. The collection channel 42 is connected to the second openings 331 in each of the second common channels 33 to allow the ink collected from each of the second common channels 33 through the second openings 331 to flow to the outlet 421.

The collection channel 42 includes an outflow connection channel 422A connected to the outlet 421, a collection chamber 422 connecting with the outlet 421 through the outflow connection channel 422A, and a collection branch channel 423 connecting with the collection chamber 422.

The outflow connection channel 422A connects the outlet 421 to the collection chamber 422. The collection chamber 422 is located farther in the first direction D11 than the middle portion of the second channel member 4 in the longitudinal direction D1, and extends in the longitudinal direction D1 of the second channel member 4. The ink flows through the collection chamber 422 parallel to the longitudinal direction D1 of the second channel member 4. The collection chamber 422 has, for example, a rectangular cross section perpendicular to the flow direction of the ink. The collection chamber 422 has the same channel cross-sectional area, which indicates an area of its cross section, across two ends of the collection chamber 422 in the longitudinal direction D1. More specifically, the collection chamber 422 has a uniform cross-sectional area in the flow direction of the ink. The collection chamber 422 can store the ink flowing out of the outlet 421, and includes an external collection opening 422B facing upward and open outward.

The collection chamber 422 is adjacent to the supply chamber 412 in the longitudinal direction D1 of the second channel member 4. The collection chamber 422 includes the external collection opening 422B covered with the elastic film 43 that is commonly used with the external supply opening 412B in the supply chamber 412. The collection chamber 422 has a volume that varies in response to elastic deformation of a portion of the elastic film 43 facing the external collection opening 422B. The elastic film 43 vibrates in response to elastic deformation that varies the volume of the collection chamber 422. The vibration of the elastic film 43 attenuates to reduce the pressure fluctuation in the collection chamber 422. With the external collection opening 422B in the collection chamber 422 covered with the elastic film 43, the pressure fluctuation, such as resonance of the ink, in the collection chamber 422 can be reduced.

Note that the external supply opening 412B in the supply chamber 412 and the external collection opening 422B in the collection chamber 422 may be covered with separate elastic films. More specifically, the external supply opening 412B in the supply chamber 412 may be covered with a first elastic film, and the external collection opening 422B in the collection chamber 422 may be covered with a second elastic film. When the external supply opening 412B in the supply chamber 412 and the external collection opening 422B in the collection chamber 422 are covered with the elastic film 43 commonly used, the first elastic film covering the external supply opening 412B and the second elastic film covering the external collection opening 422B are integral with each other as the elastic film 43.

The collection branch channel 423 connects with the collection chamber 422, and is connected to the second openings 331 to connect with the second common channels 33 in the first channel member 3. The collection branch channel 423 includes a first collection branch channel 423A and a second collection branch channel 423B.

The first collection branch channel 423A is connected to the collection chamber 422 in the middle portion of the second channel member 4 in the longitudinal direction D1, and extends in the longitudinal direction D1. The first collection branch channel 423A branches in a portion connected to the collection chamber 422 to extend in the first direction D11 and in the second direction D12. The first collection branch channel 423A is located above the first supply branch channel 413A in the second channel member 4. The first supply branch channel 413A at least partially overlaps the first collection branch channel 423A as viewed in plan in the thickness direction D3 of the second channel member 4. The ink flows through the first collection branch channel 423A parallel to the longitudinal direction D1 of the second channel member 4. The first collection branch channel 423A has, for example, a rectangular cross section perpendicular to the flow direction of the ink. The first collection branch channel 423A has the same channel cross-sectional area, which indicates an area of its cross section, across two ends of the first collection branch channel 423A in the longitudinal direction D1. More specifically, the first collection branch channel 423A has a uniform cross-sectional area in the flow direction of the ink.

The second collection branch channel 423B is connected to an end of the first collection branch channel 423A in the first direction D11 of the longitudinal direction D1 and to an end of the first collection branch channel 423A in the second direction D12 of the longitudinal direction D1 to extend in the width direction D2. The second collection branch channel 423B is connected to the second openings 331 of each of the second common channels 33 in the first channel member 3. The second collection branch channel 423B branches in a portion connected to the first collection branch channel 423A to extend in the third direction D21 of the width direction D2 and in the fourth direction D22 of the width direction D2. The ink flows through the second collection branch channel 423B parallel to the width direction D2 of the second channel member 4. The second collection branch channel 423B has, for example, a rectangular cross section perpendicular to the flow direction of the ink. The second collection branch channel 423B has the same channel cross-sectional area, which indicates an area of its cross section, across two ends of the second collection branch channel 423B. More specifically, the second collection branch channel 423B has a uniform cross-sectional area in the flow direction of the ink.

The second channel member 4 including the supply channel 41 and the collection channel 42 receives, through the external supply channel 64, supply of the ink stored in the supply storage 61 in the circulator 6 connected to the head body 21. The ink supplied to the second channel member 4 through the external supply channel 64 flows into the supply chamber 412 through the inlet 411 and the inflow connection channel 412A. The ink that has flowed into the supply chamber 412 flows into the first supply branch channel 413A through the branch connection channel 4131. The ink that has flowed into the first supply branch channel 413A flows through the first supply branch channel 413A, and then flows into the second supply branch channel 413B. The ink that has flowed into the second supply branch channel 413B is supplied, through the first openings 321 connected to the second supply branch channel 413B, to each of the first common channels 32 in the first channel member 3. In the second channel member 4, the ink collected from each of the second common channels 33 flows into the second collection branch channel 423B connected to the second openings 331 in each of the second common channels 33 in the first channel member 3. The ink that has flowed into the second collection branch channel 423B flows into the first collection branch channel 423A, flows through the first collection branch channel 423A, and then flows into the collection chamber 422. The ink that has flowed into the collection chamber 422 flows through the outflow connection channel 422A to flow out of the outlet 421. The ink that has flowed out of the outlet 421 flows, through the external collection channel 65 connected to the outlet 421, into the collection storage 62. The ink that has flowed into and stored in the collection storage 62 is pumped by the pump 63 from the collection storage 62 to the supply storage 61. In this manner, ink circulates through the head body 21 including the first channel member 3 and the second channel member 4.

As illustrated in FIG. 6, the second channel member 4 includes, on its lower surface, an accommodative space 44 for the piezoelectric actuator substrate 5. The accommodative space 44 includes through-holes 441 at ends of the second channel member 4 in the third direction D21 and the fourth direction D22 of the width direction D2. The through-holes 441 extend through to an upper surface of the second channel member 4. The through-holes 441 each receive a signal transmitter 442, such as a flexible printed circuit (FPC), that transmits a drive signal for actuating the piezoelectric actuator substrate 5.

As illustrated in FIGS. 6 to 9, the second channel member 4 has a multilayer structure in which multiple plates are stacked in the thickness direction D3. In the example in FIG. 6, the second channel member 4 includes seven plates as a first plate 4a, a second plate 4b, a third plate 4c, a fourth plate 4d, a fifth plate 4e, a sixth plate 4f, and a seventh plate 4g stacked in this order from the top.

The inlet 411 of the supply channel 41 and the outlet 421 of the collection channel 42 are defined by holes in the first and second plates 4a and 4b. The supply chamber 412 in the supply channel 41 and the collection chamber 422 in the collection channel 42 are defined by holes in the second and third plates 4b and 4c. The elastic film 43 covering both the external supply opening 412B in the supply chamber 412 and the external collection opening 422B in the collection chamber 422 is located between the first plate 4a and the second plate 4b. The inflow connection channel 412A in the supply channel 41 and the outflow connection channel 422A in the collection channel 42 are defined by the hole in the third plate 4c. The branch connection channel 4131 in the supply channel 41 is defined by a hole in the fourth plate 4d. The first supply branch channel 413A in the supply channel 41 is defined by a hole in the fifth plate 4e. The first collection branch channel 423A in the collection channel 42 is defined by a groove on the third plate 4c. The second supply branch channel 413B in the supply channel 41 is defined by holes in the fifth and sixth plates 4e and 4f. The second collection branch channel 423B in the collection channel 42 is defined by the holes in the fourth to sixth plates 4d to 4f.

The accommodative space 44 for the piezoelectric actuator substrate 5 is defined by a hole in the seventh plate 4g. The through-holes 441 through which the signal transmitters 442 extend are defined by the holes in the first to seventh plates 4a to 4g.

The piezoelectric actuator substrate 5 in the accommodative space 44 on the lower surface of the second channel member 4 is bonded to the upper surface 3A of the first channel member 3. The piezoelectric actuator substrate 5 is located with the displacement element 51 above the pressure chamber 313 of each of the individual channels 31. The piezoelectric actuator substrate 5 bonded to the upper surface 3A of the first channel member 3 covers the opening of the pressure chamber 313 in each of the individual channels 31. The piezoelectric actuator substrate 5 is connected to the signal transmitters 442, such as the FPC, for transmitting signals to the displacement element 51.

As illustrated in FIG. 5, the piezoelectric actuator substrate 5 has a multilayer structure in which two layers of piezoelectric bodies as a first piezoelectric ceramic layer 5A and a second piezoelectric ceramic layer 5B are stacked on each other. The first piezoelectric ceramic layer 5A and the second piezoelectric ceramic layer 5B extend across the multiple pressure chambers 313. The first piezoelectric ceramic layer 5A and the second piezoelectric ceramic layer 5B are made of, for example, a ferroelectric ceramic material such as lead zirconate titanate (PZT), NaNbO₃, BaTiO₃, (BiNa)NbO₃, or BiNaNb₅O₁₅.

The piezoelectric actuator substrate 5 includes a common electrode 52 made of a metal material such as a Ag—Pd material and individual electrodes 53 made of a metal material such as Au. The individual electrodes 53 are located on an upper surface of the piezoelectric actuator substrate 5 to face the respective pressure chambers 313. The individual electrodes 53 receive the drive signals from the controller 9 through the signal transmitters 442. The drive signals are provided periodically in synchronization with feeding of the workpiece W. The common electrode 52 extends planarly on substantially the entire area between the first piezoelectric ceramic layer 5A and the second piezoelectric ceramic layer 5B. More specifically, the common electrode 52 extends over all the pressure chambers 313 in the area facing the piezoelectric actuator substrate 5. The common electrode 52 is connected, through a feedthrough conductor extending through the first piezoelectric ceramic layer 5A, to a common-electrode surface electrode (not illustrated) located on the first piezoelectric ceramic layer 5A to be away from an electrode group including individual electrodes 53. The common electrode 52 is grounded through the common-electrode surface electrode and retained at a ground potential. The common-electrode surface electrode is directly or indirectly connected to the controller 9, in the same manner as or in a similar manner to the individual electrodes 53.

The first piezoelectric ceramic layer 5A has a portion between the individual electrodes 53 and the common electrode 52. The portion is polarized in the thickness direction D3 to serve as the displacement element 51 with a unimorph structure. The controller 9 controls the displacement element 51 to be actuated (to be displaced) using the drive signals provided, through a driver IC, to the individual electrodes 53. Various drive signals can be provided to cause ink ejection out of the ejection orifices 315. For example, a drive signal including pulses basically held at a high potential but at a lower potential for a fixed period is provided to the individual electrodes 53 to eject ink out of the ejection orifices 315.

More specifically, each of the individual electrodes 53 has its initial potential higher than the potential of the common electrode 52 (is initially at a higher potential). In response to any request for ejection, the individual electrodes 53 are temporarily set to the same potential as the common electrode 52 (set to a lower potential) and are then reset to the higher potential at a predetermined later time. Thus, when the individual electrodes 53 are at the lower potential, the first piezoelectric ceramic layer 5A and the second piezoelectric ceramic layer 5B start to return to their initial flat shapes, increasing the volume of the pressure chambers 313 from the volume in the initial state. This applies a negative pressure to the ink in the pressure chamber 313. The ink in the pressure chamber 313 then starts vibrating at a natural frequency. More specifically, the volume of the pressure chamber 313 starts increasing first, and the negative pressure is gradually reduced. The volume of the pressure chamber 313 then reaches the maximum, and the pressure reaches substantially zero. The volume of the pressure chamber 313 then starts decreasing, and the pressure starts increasing. After these changes, when the pressure reaches substantially the maximum, each of the individual electrodes 53 is set at the higher potential. In this state, the first vibration overlaps the second vibration, causing further higher pressure to be applied to the ink. This pressure is transmitted through the corresponding one of the descenders 314 to eject the ink out of the corresponding one of the ejection orifices 315.

In this manner, the drive signal including pulses basically held at a high potential but at a lower potential for a fixed period is provided to the individual electrodes 53, thus causing ink to be ejected out of the ejection orifices 315. When the pulse width has an acoustic length (AL) half the length of the natural frequency of the ink in the pressure chambers 313, the amount of ejected ink and the ejection speed of the ink can be theoretically maximized.

In the liquid ejection head 2 according to the present embodiment, each of the individual channels 31 includes the first narrower portion 316 connecting the corresponding one of the first common channels 32 to the pressure chamber 313, and the second narrower portion 317 connecting the corresponding one of the second common channels 33 to the pressure chamber 313. To achieve appropriate ejection of ink out of the ejection orifice 315 in each of the individual channels 31, the first narrower portion 316 is set to accurately have a higher channel resistance than the corresponding first common channel 32, the pressure chamber 313, and the descender 314. In the same or similar manner, the second narrower portion 317 is set to accurately have a higher channel resistance than the corresponding second common channel 33, the pressure chamber 313, and the descender 314.

When the channel resistance of the first narrower portion 316 or the second narrower portion 317 is too low, a pressure wave generated in the pressure chamber 313 in one of the individual channels 31 is transmitted through the corresponding one of the first common channels 32 and the corresponding one of the second common channels 33 to the other individual channels 31. This may cause crosstalk and unstable ink ejection out of the ejection orifice 315 of each of the individual channels 31. Such crosstalk can cause difficulty in appropriately electing ink out of the ejection orifice 315 in each of the individual channels 31. When the channel resistance of the first narrower portion 316 or the second narrower portion 317 is too high, the amount of ink supplied to each of the individual channels 31 from the corresponding one of the first common channels 32 is decreased, and the amount of ink collected from each of the individual channels 31 to the corresponding one of the second common channels 33 is also decreased. This state can also cause difficulty in appropriately ejecting ink out of the ejection orifice 315 in each of the individual channels 31. To achieve appropriate ejection of ink out of the ejection orifice 315 in each of the individual channels 31, the channel resistances of the first narrower portion 316 and the second narrower portion 317 are set accurately to relatively greater values.

In the liquid ejection head 2 according to the present embodiment, each of the individual channels 31 includes the first narrower portion 316 and the second narrower portion 317 designed to have a difference in channel resistance within a predetermined acceptable range. This allows the channel resistances of the first narrower portion 316 and the second narrower portion 317 located on opposite sides of the pressure chamber 313 to be set to relatively greater values more accurately than when the first narrower portion 316 and the second narrower portion 317 have a difference in channel resistance outside the predetermined acceptable range. This thus allows appropriate ejection of ink out of the ejection orifice 315 in each of the individual channels 31.

In the present embodiment, the second narrower portion 317 may have a lower channel resistance than the first narrower portion 316 by 15% or less of the channel resistance of the first narrower portion 316. More specifically, 0.85R1≤R2≤R1 is satisfied, where R1 is the channel resistance of the first narrower portion 316, and R2 is the channel resistance of the second narrower portion 317. This allows appropriate ejection of ink out of the ejection orifice 315 and allows the ink not ejected out of the ejection orifice 315 to easily flow, through the second narrower portion 317, into the corresponding one of the second common channels 33. In this case, the second narrower portion 317 having a larger channel cross-sectional area than the first narrower portion 316 can have a lower channel resistance than the first narrower portion 316.

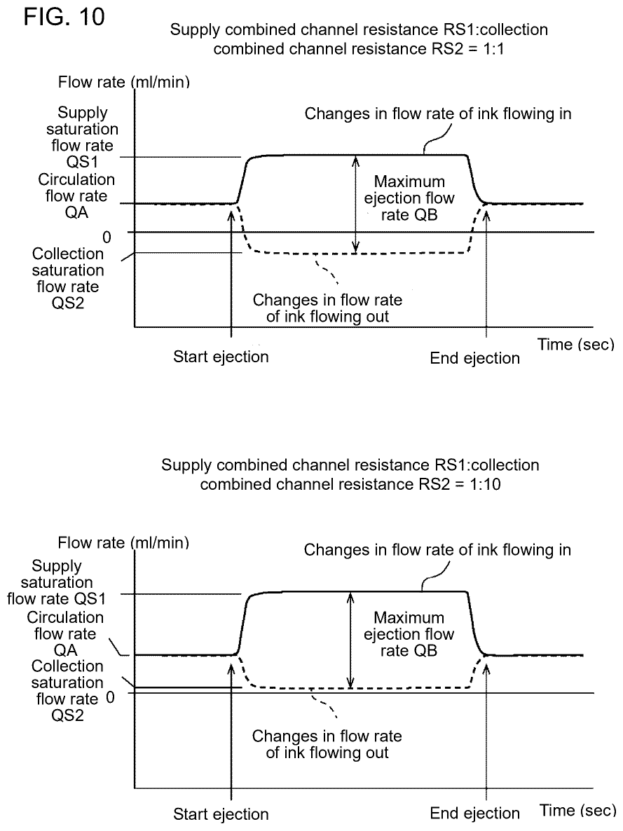

While ink circulates through the head body 21 in response to operation of the pump 63 in the circulator 6, the displacement element 51 above the pressure chamber 313 in each of the individual channels 31 may be actuated. In this case, the ink supplied from the supply channel system including the supply channel 41 and the corresponding one of the first common channels 32 to the pressure chamber 313 through the first narrower portion 316 is partially ejected out of the ejection orifice 315. When the flow rate of the ink ejected out of the ejection orifice 315 in each of the individual channels 31 is higher than a predetermined value, the ink may flow back to each of the individual channels 31 from the collection channel system including the corresponding one of the second common channels 33 and the collection channel 42 through the second narrower portion 317. The ink flowing back to each of the individual channels 31 will now be described with reference to graphs showing changes in the flow rate in FIG. 10.

When the pump 63 in the circulator 6 is operated, ink circulates in the head body 21 at a preset circulation flow rate QA through the supply channel system including the supply channel 41 and the first common channels 32, the individual channels 31, and the collection channel system including the second common channels 33 and the collection channel 42. In response to the displacement element 51 being actuated while ink circulates at the circulation flow rate QA, the ink supplied from the supply channel system including the supply channel 41 and the first common channels 32 to the pressure chambers 313 through the first narrower portions 316 in the individual channels 31 is ejected out of the ejection orifices 315 at an ejection flow rate based on the print data. The ink not ejected out of the ejection orifices 315 then flows through the second narrower portions 317 to be collected by the collection channel system including the collection channel 42 and the second common channels 33.

When ink ejection out of the ejection orifices 315 starts in response to actuation of the displacement element 51, the flow rate of the ink flowing through the inlet 411 into the supply channel 41 gradually increases from the circulation flow rate QA to reach a supply saturation flow rate QS1 indicating the saturation flow rate of the ink flowing sequentially through the supply channel 41, the first common channels 32, and the first narrower portions 316. The ink flowing through the inlet 411 into the supply channel 41 is retained constant at the supply saturation flow rate QS1 while ink is being ejected out of the ejection orifices 315 at the ejection flow rate based on the print data. When the ejection of ink out of the ejection orifices 315 ends, the flow rate of the ink flowing through the inlet 411 into the supply channel 41 gradually decreases from the supply saturation flow rate QS1 to return to the circulation flow rate QA.

When ink ejection out of the ejection orifices 315 is started in response to actuation of the displacement element 51, the flow rate of the ink flowing out of the outlet 421 of the collection channel 42 gradually decreases from the circulation flow rate QA to reach a collection saturation flow rate QS2 indicating the saturation flow rate of the ink flowing sequentially through the second narrower portions 317, the second common channels 33, and the collection channel 42. The ink flowing out of the outlet 421 of the collection channel 42 is retained constant at the collection saturation flow rate QS2 while ink is being ejected out of the ejection orifices 315 at the ejection flow rate based on the print data. When the ejection of ink out of the ejection orifices 315 ends, the flow rate of the ink flowing out of the outlet 421 of the collection channel 42 gradually increases from the collection saturation flow rate QS2 to return to the circulation flow rate QA.

To reduce viscosity increase of ink resulting from evaporation of volatile components in the ink, the circulation flow rate QA of the ink circulating through the head body 21 is preset to regulate accumulation of ink around the ejection orifices 315 that are open outward in the head body 21. For the head body 21, a maximum ejection flow rate QB indicating the maximum acceptable ejection flow rate of the ink ejected out of the ejection orifices 315 is preset. The maximum ejection flow rate QB is set to, for example, a value greater than twice the circulation flow rate QA.

For the supply channel 41 and the first common channels 32 as the supply channel system, the first narrower portions 316 and the second narrower portions 317 in the individual channels 31, and the second common channels 33 and the collection channel 42 as the collection channel system, a channel resistance R of each of these channels having a rectangular cross section is calculated as in Formula 1 below.

$$R = \frac{64 vL}{{ab}^{3} X} \qquad ( 1 )$$

In Formula 1, “a” is a length of a long side of the rectangular cross section, “b” is a length of a short side of the rectangular cross section, “L” is a length of each of the above channels in the flow direction of the ink, and “v” is the viscosity of the ink. Note that “X” in Formula 1 is calculated as in Formula 2 below.

$$X = \frac{16}{3} - \frac{1024}{{π}^{5}} \frac{b}{a} {\sum }_{i = 1 , 3 , 5 ,} \frac{1}{{i}^{5}} tanh \frac{i π a}{2 b} \qquad ( 2 )$$

In Formula 2, “a” and “b” are the same as in Formula 1, “π” is a circumference ratio, and “h” is an attenuation constant.

Based on Formula 1, for the supply channel 41 and the first common channels 32 as the supply channel system, the first narrower portions 316 and the second narrower portions 317 in the individual channels 31, and the second common channels 33 and the collection channel 42 as the collection channel system, the channel resistance R of each of the channels can be adjusted based on the channel cross-sectional area or the length of the corresponding one of the channels. In the present embodiment, the channel resistance R of each of the channels is adjusted based on the channel cross-sectional area of the corresponding one of the channels.

The supply saturation flow rate QS1 while ink is being ejected out of the ejection orifices 315 at the maximum ejection flow rate QB is calculated based on Formula 3 below using the circulation flow rate QA and the maximum ejection flow rate QB.

$$Q S 1 = Q A + Q B \times \frac{R S 2}{RS 1 + RS 2} \qquad ( 3 )$$

In Formula 3, “RS1” is a supply combined channel resistance indicating a combined channel resistances of each of the first common channels 32, the supply channel 41, and the corresponding one of the first narrower portions 316, and “RS2” is a collection combined channel resistance indicating a combined channel resistance of each of the second common channels 33, the collection channel 42, and the corresponding one of the second narrower portions 317.

Based on Formula 3, the supply saturation flow rate QS1 is determined based on the preset circulation flow rate QA, the maximum ejection flow rate QB, the supply combined channel resistance RS1, and the collection combined channel resistance RS2.

The collection saturation flow rate QS2 while ink is being ejected out of the ejection orifices 315 at the maximum ejection flow rate QB is calculated based on the supply saturation flow rate QS1 and the maximum ejection flow rate QB as in Formula 4 below.

$$QS 2 = Q S 1 - Q B \qquad ( 4 )$$

The collection saturation flow rate QS2 is calculated based on the supply saturation flow rate QS1 and the maximum ejection flow rate QB. Thus, the collection saturation flow rate QS2 is determined based on the preset circulation flow rate QA, the maximum ejection flow rate QB, the supply combined channel resistance RS1, and the collection combined channel resistance RS2, in the same manner as or in a similar manner to the supply saturation flow rate QS1.

The supply combined channel resistance RS1 and the collection combined channel resistance RS2 may be the same when the maximum ejection flow rate QB is set higher than twice the circulation flow rate QA. In this case, the collection saturation flow rate QS2 is less than zero based on Formula 3 and Formula 4. For example, when the supply combined channel resistance RS1 and the collection combined channel resistance RS2 are the same at a circulation flow rate QA of 20 ml/min and a maximum ejection flow rate QB of 100 ml/min, the supply saturation flow rate QS1 is 70 ml/min based on Formula 3, and the collection saturation flow rate QS2 is −30 ml/min based on Formula 4. The collection saturation flow rate QS2 is thus less than zero. When the collection saturation flow rate QS2 is less than zero, ink flows back from the collection channel system including the second common channels 33 and the collection channel 42 to the respective individual channels 31 through the respective second narrower portions 317, while ink is being ejected out of the ejection orifices 315.

When ink flows back from the collection channel system including the second common channels 33 and the collection channel 42 to the respective individual channels 31 through the respective second narrower portions 317, the ink flowing back to the respective individual channels 31 is ejected out of the respective ejection orifices 315. In this state, the ink ejected in droplets may reach the workpiece W and degrade the quality of the image on the workpiece W. For example, when the supply channel system including the first common channels 32 and the supply channel 41 includes the first filters 311A and the second filter 412C and the collection channel system includes no filter, ink containing, for example, foreign substances can flow back from the collection channel system to the respective individual channels 31 through the respective second narrower portions 317. In this case, the ink containing, for example, foreign substances is ejected out of the ejection orifices 315, and the foreign substances may degrade the quality of the image on the workpiece W.

To reduce the likelihood that the ink flows back from the collection channel system including the second common channels 33 and the collection channel 42 to the respective individual channels 31 through the respective second narrower portions 317 while ink is being ejected out of the respective ejection orifices 315, the collection saturation flow rate QS2 based on the supply saturation flow rate QS1 and the maximum ejection flow rate QB is to be retained at zero or greater while ink is being ejected out of the respective ejection orifices 315, as expressed in Formula (5) below.

$$QS 2 = Q S 1 - Q B \geq 0 \qquad ( 5 )$$

In the liquid ejection head 2 according to the present embodiment, the collection combined channel resistance RS2, which indicates the combined channel resistance of each of the second common channels 33, the collection channel 42, and the corresponding one of the second narrower portions 317, is higher than the supply combined channel resistance RS1, which indicates the combined channel resistance of each of the first common channels 32, the supply channel 41, and the corresponding one of the first narrower portions 316. More specifically, the collection combined channel resistance RS2, which indicates the combined channel resistance of the collection channel 42, each of the second common channels 33 connected to the collection channel 42, and the second narrower portion 317 connected to each of the second common channels 33, is higher than the supply combined channel resistance RS1, which indicates the combined channel resistance of the supply channel 41, each of the first common channels 32 connected to the supply channel 41, and the first narrower portion 316 connected to each of the first common channels 32. For example, the ratio of the supply combined channel resistance RS1 to the collection combined channel resistance RS2 may be 1:10 at a circulation flow rate QA of 20 ml/min and a maximum ejection flow rate QB of 100 ml/min. In this case, the supply saturation flow rate QS1 is 110.9 ml/min based on Formula 3, and the collection saturation flow rate QS2 is 10.9 ml/min based on Formula 4. Thus, the collection saturation flow rate QS2 satisfies Formula 5 and is not less than zero.

The flow rate of the ink flowing out of the outlet 421 of the collection channel 42 can have small changes between the circulation flow rate QA and the collection saturation flow rate QS2 when the collection combined channel resistance RS2 is higher than the supply combined channel resistance RS1, compared with when the collection combined channel resistance RS2 is the same as the supply combined channel resistance RS1. Thus, for the flow rate of the ink flowing out of the outlet 421, the collection saturation flow rate QS2 is less likely to be less than zero, and ink is less likely to flow back from the collection channel system including the second common channels 33 and the collection channel 42 to the respective individual channels 31 through the respective second narrower portions 317.

To reliably reduce the likelihood that ink flows back from the collection channel system to the respective individual channels 31 through the respective second narrower portions 317, the collection combined channel resistance RS2 is set higher than the supply combined channel resistance RS1 to satisfy Formula 6 below using the circulation flow rate QA and the maximum ejection flow rate QB, which are derived from Formulas 3 and 5.

$$\frac{RS 2}{RS 1 + RS 2} \geq \frac{QB - QA}{QB} \qquad ( 6 )$$

As described above based on Formula 1, the channel resistance R of each of the supply channel 41 and the first common channels 32 as the supply channel system, the first narrower portions 316 and the second narrower portions 317 in the individual channels 31, and the second common channels 33 and the collection channel 42 as the collection channel system can be adjusted based on the channel cross-sectional area of the corresponding one of the channels. In the present embodiment, the sum of the channel cross-sectional areas of each of the second common channels 33, the collection channel 42, and the corresponding one of the second narrower portions 317 is less than the sum of the channel cross-sectional areas of each of the first common channels 32, the supply channel 41, and the corresponding one of the first narrower portions 316. In this structure, the collection combined channel resistance RS2 is higher than the supply combined channel resistance RS1.

In the present embodiment, the second common channels 33 have higher channel resistances R than the first common channels 32. For example, when the second common channels 33 have smaller channel cross-sectional areas than the first common channels 32, the second common channels 33 can have higher channel resistances R than the first common channels 32. In this structure, the collection combined channel resistance RS2 can be set higher than the supply combined channel resistance RS1. This more reliably reduces the likelihood that ink flows back from the collection channel system including the second common channels 33 and the collection channel 42 to the respective individual channels 31 through the respective second narrower portions 317.

In the present embodiment, the collection channel 42 has a higher channel resistance R than the supply channel 41. More specifically, the first collection branch channel 423A in the collection branch channel 423 in the collection channel 42 has a higher channel resistance R than the first supply branch channel 413A in the supply branch channel 413 in the supply channel 41. For example, when the first collection branch channel 423A has a smaller channel cross-sectional area than the first supply branch channel 413A, the first collection branch channel 423A can have a higher channel resistance R than the first supply branch channel 413A. In this structure, the collection combined channel resistance RS2 can be set higher than the supply combined channel resistance RS1. This more reliably reduces the likelihood that ink flows back from the collection channel system including the second common channels 33 and the collection channel 42 to the respective individual channels 31 through the respective second narrower portions 317.

In the present embodiment, the second common channels 33 have higher channel resistances R than the first common channels 32, and the collection channel 42 has a higher channel resistance R than the supply channel 41. In this structure, the collection combined channel resistance RS2 can be set higher than the supply combined channel resistance RS1. This more reliably reduces the likelihood that ink flows back from the collection channel system including the second common channels 33 and the collection channel 42 to the respective individual channels 31 through the respective second narrower portions 317.

In the circulator 6 outside the liquid ejection head 2, the external collection channel 65 connected to the outlet 421 of the collection channel 42 may have a higher channel resistance than the external supply channel 64 connected to the inlet 411 of the supply channel 41. This also reduces the likelihood that ink flows back from the collection channel system including the second common channels 33 and the collection channel 42 to the respective individual channels 31 through the respective second narrower portions 317.

For the flow rate of the ink flowing through the inlet 411 into the supply channel 41 and the flow rate of the ink flowing out of the outlet 421 of the collection channel 42, the trend of changes in the flow rates at the start of ejection of the ink through each of the ejection orifices 315 is determined based on a pressure loss P expressed as in Formula 7 and an attenuation ratio d expressed as in Formula 8.

$$P = R Δ U \qquad ( 7 )$$

In Formula 7, “R” is the channel resistance of each of the channels included in the supply channel system and the collection channel system, and “U” is changes in the flow rate of the ink flowing in and the flow rate of the ink flowing out.

$$d = \frac{{CR}^{2}}{4 M} \qquad ( 8 )$$

In Formula 8, “C” is compliance of each of the supply chamber 412 and the collection chamber 422, “R” is the channel resistance of each of the channels included in the supply channel system and the collection channel system, and “M” is inertance of each of the supply chamber 412 and the collection chamber 422.

The compliance C of each of the supply chamber 412 and the collection chamber 422 indicates the volume of displacement per unit pressure based on elastic deformation of the elastic film 43 covering the external supply opening 412B in the supply chamber 412 and the external collection opening 422B in the collection chamber 422. The compliance C is defined by C=ΔV/Δp, where V is the volume of the ink in each of the channels, and p is the pressure applied to the ink in each of the channels. The inertance M of each of the supply chamber 412 and the collection chamber 422 is defined by M=μL/S, where ρ is density of the ink, L is the length of each of the channels in the flow direction of the ink, and S is the channel cross-sectional area.

In the present embodiment, the collection combined channel resistance RS2 is higher than the supply combined channel resistance RS1. Thus, the collection chamber 422 in the collection channel system has a higher attenuation ratio than the supply chamber 412 in the supply channel system based on Formula 8. In this structure, at the start of ink ejection out of each of the ejection orifices 315, the pressure vibration of the ink is greater in the supply chamber 412 in the supply channel system than in the collection chamber 422 in the collection channel system.

Thus, when the collection combined channel resistance RS2 is higher than the supply combined channel resistance RS1, the supply chamber 412 has a greater compliance C than the collection chamber 422 to match the attenuation ratio d of the supply chamber 412 with the attenuation ratio d of the collection chamber 422. In this case, the inertance M of the supply chamber 412 is to be the same as the inertance M of the collection chamber 422.

The compliance C of the supply chamber 412 can be adjusted based on, for example, an opening area of the external supply opening 412B covered with the elastic film 43 in the supply chamber 412. In the same or similar manner, the compliance C of the collection chamber 422 can be adjusted based on, for example, an opening area of the external collection opening 422B covered with the elastic film 43 in the collection chamber 422. Note that, when the external supply opening 412B in the supply chamber 412 is covered with the first elastic film as the elastic film 43 and the external collection opening 422B in the collection chamber 422 is covered with the second elastic film as the elastic film 43, the compliance C of each of the supply chamber 412 and the collection chamber 422 may be adjusted based on Young's modulus for elastic deformation of each of the first elastic film and the second elastic film or the thickness of the elastic film 43.

To match the attenuation ratio d of the supply chamber 412 with the attenuation ratio d of the collection chamber 422, the supply chamber 412 may have the greater compliance C than the collection chamber 422. In this state, at the start of ink ejection out of each of the ejection orifices 315, the pressure vibration of the ink in the supply chamber 412 matches the pressure vibration of the ink in the collection chamber 422.

### REFERENCE SIGNS

1 printer (liquid ejection apparatus)
2 liquid ejection head
3 first channel member
31 individual channel
311 one end
312 other end
313 pressure chamber
315 ejection orifice
316 first narrower portion
317 second narrower portion
32 first common channel
321 first opening
33 second common channel
331 second opening
4 second channel member
41 supply channel
411 inlet
412 supply chamber
42 collection channel
421 outlet
422 collection chamber
43 elastic film
5 piezoelectric actuator substrate
51 displacement element (pressure applier)
6 circulator
61 supply storage
62 collection storage
63 pump
64 external supply channel
65 external collection channel

1. A liquid ejection head, comprising:
a plurality of individual channels through which a liquid flows, each of the plurality of individual channels including one end, another end, and an ejection orifice located between the one end and the other end to eject the liquid;
a first common channel including a first opening and connected to the one end of each of the plurality of individual channels;
a second common channel including a second opening and connected to the other end of each of the plurality of individual channels;
a supply channel including an inlet through which the liquid flows in from outside, the supply channel being connected to the first opening in the first common channel, and the supply channel configured to supply the liquid flowing in through the inlet to the first common channel through the first opening; and
a collection channel including an outlet through which the liquid flows to the outside, the collection channel being connected to the second opening in the second common channel, and the collection channel configured to allow the liquid collected from the second common channel through the second opening to flow to the outlet,
wherein each of the plurality of individual channels includes
a pressure chamber located between the one end and the other end and connected with the ejection orifice, the pressure chamber having a pressure applier configured to apply pressure to the pressure chamber,
a first narrower portion located between the one end and the pressure chamber and having a higher channel resistance than the pressure chamber, and
a second narrower portion located between the other end and the pressure chamber and having a higher channel resistance than the pressure chamber, and
a combined channel resistance of the second common channel, the collection channel, and the second narrower portion is higher than a combined channel resistance of the first common channel, the supply channel, and the first narrower portion.

2. The liquid ejection head according to claim 1, wherein
the first narrower portion and the second narrower portion have a difference in channel resistance within a predetermined acceptable range.

3. The liquid ejection head according to claim 2, wherein
the second narrower portion has a lower channel resistance than the first narrower portion by 15% or less of a channel resistance of the first narrower portion.

4. The liquid ejection head according to claim 1, wherein
the second common channel has a higher channel resistance than the first common channel.

5. The liquid ejection head according to claim 1, wherein
the collection channel has a higher channel resistance than the supply channel.

6. The liquid ejection head according to claim 1, wherein
the second common channel has a higher channel resistance than the first common channel, and
the collection channel has a higher channel resistance than the supply channel.

7. The liquid ejection head according to claim 1, wherein
the supply channel includes a supply chamber connecting with the inlet to store the liquid flowing in through the inlet, and the supply chamber includes an external supply opening being open to the outside,
the collection channel includes a collection chamber connecting with the outlet to store the liquid flowing out of the outlet, and the collection chamber includes an external collection opening being open to the outside,
the external supply opening in the supply chamber is covered with a first elastic film being elastically deformable,
the external collection opening in the collection chamber is covered with a second elastic film being elastically deformable,
the supply chamber has a compliance indicating a volume of deformation per unit pressure based on elastic deformation of the first elastic film,
the collection chamber has a compliance indicating a volume of displacement per unit pressure based on elastic deformation of the second elastic film, and
the supply chamber has a greater compliance than the collection chamber.

8. The liquid ejection head according to claim 7, wherein
the first elastic film and the second elastic film are integral with each other.

9. A liquid ejection head, comprising:
a plurality of individual channels through which a liquid flows, each of the plurality of individual channels including one end, another end, and an ejection orifice located between the one end and the other end to eject the liquid;
a first common channel including a first opening and connected to the one end of each of the plurality of individual channels;
a second common channel including a second opening and connected to the other end of each of the plurality of individual channels;
a supply channel including an inlet through which the liquid flows in from outside, the supply channel being connected to the first opening in the first common channel, and the supply channel configured to supply the liquid flowing in through the inlet to the first common channel through the first opening; and
a collection channel including an outlet through which the liquid flows to the outside, the collection channel being connected to the second opening in the second common channel, and the collection channel configured to allow the liquid collected from the second common channel through the second opening to flow to the outlet,
wherein each of the plurality of individual channels includes
a pressure chamber located between the one end and the other end and connected with the ejection orifice, the pressure chamber having a pressure applier configured to apply pressure to the pressure chamber,
a first narrower portion located between the one end and the pressure chamber and having a higher channel resistance than the pressure chamber, and
a second narrower portion located between the other end and the pressure chamber and having a higher channel resistance than the pressure chamber, and
a sum of channel cross-sectional areas of the second common channel, the collection channel, and the second narrower portion is less than a sum of channel cross-sectional areas of the first common channel, the supply channel, and the first narrower portion.

10. A liquid ejection apparatus, comprising:
the liquid ejection head according to claim 1; and
a circulator connected to the inlet and the outlet of the liquid ejection head, the circulator being configured to circulate the liquid through the liquid ejection head.

11. The liquid ejection apparatus according to claim 10, wherein
the circulator includes
a supply storage configured to store the liquid to be supplied to the inlet of the liquid ejection head,
a collection storage configured to store the liquid flowing out of the outlet of the liquid ejection head,
a pump configured to pump the liquid from the collection storage to the supply storage,
an external supply channel connecting the supply storage to the inlet to allow the liquid stored in the supply storage to flow to the inlet, and
an external collection channel connecting the collection storage to the outlet to allow the liquid flowing out of the outlet to flow to the collection storage, and
the external collection channel has a higher channel resistance than the external supply channel.
